(19) United States
(12) Patent Application Publication
(10) Pub. No.: US 2007/0140699 A1
(43) Pub. Date: Jun. 21, 2007

(54) Radio-over-fiber link device using multi-mode fiber and method of setting signal band thereof

(75) Inventors: Sung-Kee Kim, Suwon-si (KR); Hoon Kim, Suwon-si (KR); Han-Lim Lee, Seoul (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/639,965

(22) Filed: Dec. 15, 2006

(30) Foreign Application Priority Data
Dec. 15, 2005 (KR) 124118/2005

(51) Int. Cl. H04B 10/00

(52) U.S. Cl. 398/140

(57) ABSTRACT

Disclosed is a method of setting a signal band of a Radio-Over-Fiber (ROF) link device using a Multi-Mode Fiber (MMF), which includes the steps of dividing a preset band of the entire frequency band of the MMF as a plurality of frequency slots to preset a transmission band in a transmitting side device, sequentially sweeping a plurality of reference frequencies predetermined for each transmission band of the plurality of the frequency slots to only the bands of the corresponding frequency slots, identifying the possibility of signal transmission for each of the plurality of frequency slots in accordance with transmission quality information transmitted from a receiving side to set a transmission signal band, detecting the quality of a signal received for the corresponding frequency slot when sweeping a frequency for each of the plurality of frequency slots in the receiving side device, and transmitting the transmission quality information to the transmitting side device in accordance with the detected signal quality.

### CLAIM OF PRIORITY

This application claims the benefit of the earlier filing date, pursuant to 35 USC 119, to that patent application entitled “Radio-Over-Fiber Link Device Using Multi-Mode Fiber and Method of Setting Signal Band Thereof” filed with the Korean Intellectual Property Office on Dec. 15, 2005 and assigned Serial No. 2005-124118, the contents of which are incorporated herein by reference.

### BACKGROUND OF THE INVENTION

1. Field of the Invention

The present invention relates to a link device for processing various service signals through a multi-mode fiber and a method of setting a signal transmission band of the link device.

2. Description of the Related Art

There has been an increasing necessity to provide high-speed wireless multimedia communication services by combining optical and radio communication technologies due to the diversification and rapid increase of information communication services. Accordingly, interest in technology for linking ultrahigh frequencies with high-speed optical communication networks has been concentrated in order to enable various kinds of high-capacity multimedia information communication services by combining wired and wireless technologies. Further, studies on integration technology through combination of the two technologies, i.e., Radio-Over-Fiber (ROF) technology simultaneously with optical communication technology for high-speed transmission and radio communication technology for mobility, has been actively conducted.

In such ROF technology, the basic components are an optical link device for modulating a transmission signal in a microwave band and then converting it into an optical signal to transmit it through an optical fiber, a radio link device for transmitting a signal received through the optical fiber by radio, and the like. Further, studies for effectively providing various wireless services for voice, broadcasting, data and the like have been actively conducted considering broadband requirements and characteristics of optical and radio communications.

At this time, it is inefficient to configure a remote antenna link for all services in an environment in which there are provided various wireless services for voice, broadcasting, data and the like. Thus, ROF link technology enhances efficiency by allowing several wireless services to be simultaneously transmitted on one link. Such an ROF link is generally configured using a Single-Mode Fiber (SMF). This is because the SMF has a broadband to be used in view of the property of an optical fiber, and can be transmitted a long distance due to small color dispersion. However, coupling efficiency is greatly lowered in a connection with a light emitting or receiving element due to a small core radius of the SMF. On the other hand, since, in a case of a Multi-Mode Fiber (MMF), its core radius is large, coupling efficiency is high so that the MMF is very suitable for applications in a more local area, e.g., within a building.

FIG. 1 is an exemplary view showing a frequency characteristic graph of a general MMF. As shown in FIG. 1, in a case of the MMF, it can be seen that a 3 dB band, which is a transmission band, is narrowly formed due to the influence of dispersion between the respective modes. That is, it can be seen that the frequency characteristic has a monotonous decreasing characteristic within the bandwidth of an optical fiber (i.e., within the 3 dB band) and an irregular characteristic as a frequency increases. Such an irregular characteristic is a function of the length and connection state of the optical fiber due to coupling between the respective modes. Thus, in a conventional case, an ROF link is configured using a low-frequency intermediate frequency (IF) with a monotonous decreasing frequency characteristic.

However, in this case, there is a difficulty in simultaneously receiving various service signals in only a narrow bandwidth of the MMF.

### SUMMARY OF THE INVENTION

Accordingly, the present invention has been made to solve the above-mentioned problems occurring in the prior art and provides additional advantages, by providing an ROF link device using an MMF for simultaneously receiving various wireless services effectively with an easy and simple configuration in a case where an ROF link is configured using the MMF, and a method of setting a signal band of the ROF link device.

According to one aspect of the present invention, there is provided a method of setting a signal band of a Radio-Over-Fiber (ROF) link device using a multi-mode fiber, which includes the steps of dividing a preset band from the entire frequency scanning band of the MMF into a plurality of frequency slots to preset a transmission band in a transmitting side device, sequentially sweeping a plurality of reference frequencies predetermined for each transmission band of the plurality of the frequency slots to only the bands of the corresponding frequency slots, identifying the possibility of signal transmission for each of the plurality of frequency slots in accordance with transmission quality information transmitted from a receiving side to set a transmission signal band, detecting the quality of a signal received for the corresponding frequency slot when sweeping a frequency for each of the plurality of frequency slots in the receiving side device, and transmitting the transmission quality information to the transmitting side device in accordance with the detected signal quality.

According to a second aspect of the present invention, there is provided an ROF link device using a Multi-Mode Fiber (MMF), which includes a transmitting side oscillator bank and switch having a plurality of oscillators, each of which generates a reference frequency with a transmission band set for each frequency slot in a case where a preset band from the entire frequency band of the MMF is divided into a plurality of the frequency slots with the same bandwidth, and for selecting one of the plurality of oscillators under the control of a transmitting side processor unit, a frequency sweep module for outputting a variable frequency to sweep a frequency band corresponding to one of the frequency slots under the control of the transmitting side processor unit, a first mixer for synthesizing outputs of the frequency sweep module and the oscillator bank & switch, a transmitting side filter bank & switch having a plurality of filters with filtering bands respectively set for the plurality of frequency slots to select a signal output from the first mixer to pass through the filter with the corresponding frequency band under the control of the transmitting side processor unit, and a transmitting side device having the transmitting side processor unit for controlling the frequency sweep module, oscillator bank & switch and filter bank and switch to transmit a corresponding optical signal to the receiving side device for each of the frequency slots, and receiving information on the quality of a corresponding transmitted signal transmitted from the receiving side device in order to identify frequency bands of the MMF possible for signal transmission.

The ROF link device includes a receiving side filter bank and switch having a plurality of filters, each of which receives a signal divided for each number of frequency slots through the receiving side device to filter the divided signal with each transmission band set for each of the frequency slots under the control of a receiving side processor unit, and for switching a path such that each of the signals filtered from the plurality of filters can be output to a preset output line in accordance with the signal band of an original signal, a receiving side oscillator bank and switch having a plurality of oscillators, each of which generates a reference signal for modulating a frequency with each transmission band set for each of the frequency slots to the signal band of an original signal, and for selecting one of the plurality of oscillators under the control of the receiving side processor unit, a plurality of mixers each of which is provided for each output line of the receiving side filter bank and switch, and synthesizes an output of the filter bank and switch and an output of the receiving side oscillator bank and switch to modulate it to the signal band of an original signal, a plurality of ban pass filters for respectively filtering output signals of the plurality of mixers in corresponding frequency bands, a Performance monitoring Module (PM) for measuring the signal quality of output signals of the plurality of band pass filters and a receiving side device having the receiving side processor unit for controlling the receiving side filter bank & switch and oscillator bank and switch in accordance with a control signal transmitted from the transmitting side device to measure signal quality for each of the frequency slots through the PM, and to transmit information on the signal quality detected from the PM to the transmitting side device.

### BRIEF DESCRIPTION OF THE DRAWINGS

The above features and advantages of the present invention will be more apparent from the following detailed description taken in conjunction with the accompanying drawings, in which:

FIG. 1 is an view showing graph of an exemplary frequency characteristic of a general MMF;

FIG. 2 is a graph showing an exemplary frequency characteristic of an MMF, in which signal transmittable bands are displayed;

FIG. 3 is a graph showing an exemplary frequency characteristic of an MMF for illustrating a method of setting a signal transmission band according to a first embodiment of the present invention;

FIGS. 4A and 4B are block diagrams showing a configuration of an ROF link device using the MMF according to the first embodiment of the present invention;

FIGS. 5A and 5B are detailed block diagrams showing configurations of a filter bank and switch and an oscillator and switch in FIGS. 4a and 4b, respectively;

FIGS. 6A and 6B are block diagrams showing a configuration of an ROF link device using an MMF according to a second embodiment of the present invention;

FIGS. 7A and 7B are detailed block diagrams showing configurations of mixer/oscillator/filter banks in FIGS. 6A and 6B, respectively; and

FIG. 8 is a block diagram showing a configuration of a transmitting side device in an ROF link device using an MMF according to a third embodiment of the present invention.

### DETAILED DESCRIPTION

Hereinafter, embodiments of the present invention will be described with reference to the accompanying drawings. In the following description, the same elements will be designated by the same reference numerals although they are shown in different drawings. For the purposes of clarity and simplicity, a detailed description of known functions and configurations incorporated herein will be omitted as it may make the subject matter of the present invention rather unclear.

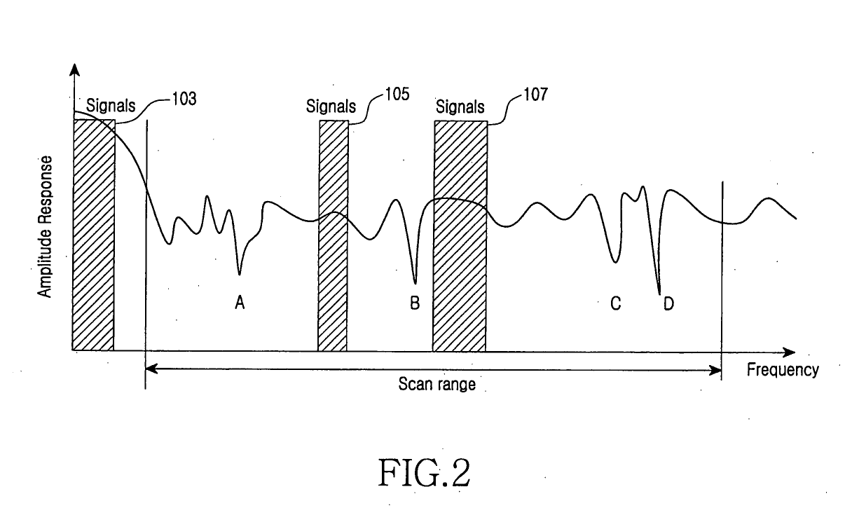

FIG. 2 is a graph of an exemplary frequency characteristic of a Multi-Mode Fiber (MMF), in which signal transmittable bands, 103, 105, 107 are displayed. Referring to FIG. 2, since the bandwidth of the MMF is too narrow to simultaneously receive several services using only an existing band 103 when the MMF is used, and in order to use a region larger than an existing bandwidth, regions outside the conventional bandwidth 103 may be identified and used in signal transmission.

That is, in a case of a region other than the conventional bandwidth 103 of the MMF, the frequency characteristic thereof depends on the length and connection state of an optical fiber due to coupling between modes as shown in FIG. 2. Since a frequency characteristic is not monotonously decreasing but has several ripples, dips, peaks and the like, and the characteristic is random, particularly in frequency ranges outside the conventional bandwidth, it is difficult to find a general characteristic. Thus, in a case where an ROF link is configured using a specific IF band, a transmission characteristic is changed whenever the ROF link is configured. Accordingly, it may be determined the characteristics of a frequency region outside the bandwidth of an optical fiber has through a scanning operation, and a proper frequency band can be selected for use in signal transmission therethrough.

As a configuration for this, there may be considered a plan of including a sweep oscillator for sweeping the entire frequency band of a corresponding MMF and a variable frequency band pass filter for the purpose of scanning the frequency band of the MMF. However, in this case, the scan region of an available frequency band of the MMF may be reduced due to a limitation of a desired variable frequency, and such a configuration of the sweep oscillator and the variable frequency band pass filter may not be better than a fixed frequency oscillator and a fixed frequency band pass filter in terms of price or performance. Further, in this case, a control function for stability is additionally required when the configuration is used for a long period of time.

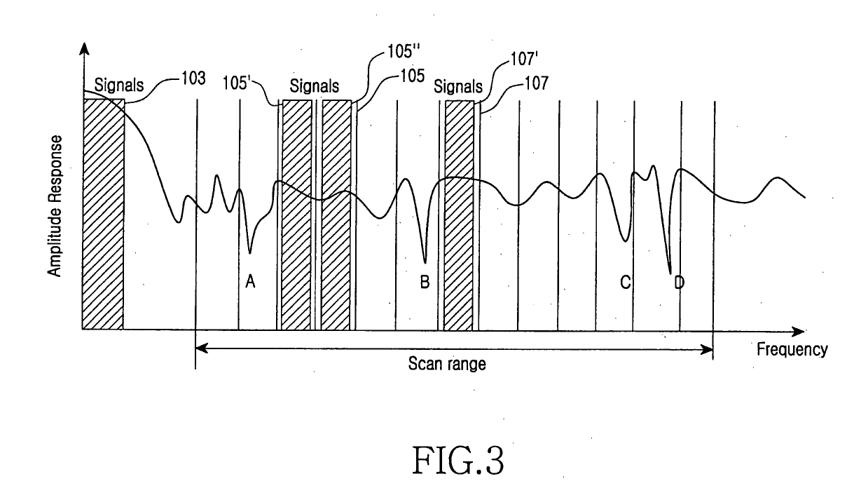

Therefore, the present invention provides a plan of identifying available frequency bands by scanning the entire frequency band of the MMF by using a plurality of fixed frequency oscillators and fixed frequency band pass filters. To this end, the present invention uses a plurality of fixed frequency oscillator banks (and various combinations, thereof) and fixed frequency band pass filter banks. Thus, the entire frequency scanning band is divided into a plurality of intervals, i.e., frequency slots 105′, 105″, 107′, to select IF frequencies as shown in FIG. 3. Here, the number of slots is determined with the number of oscillators and band pass filters respectively contained in the oscillator bank and the band pass filter bank.

Further, in order to understand the frequency characteristic of the MMF, the present invention has a Frequency Sweep Module (FSM) capable of sweeping a frequency range in a transmitter. As shown in FIG. 3, the frequency sweep range of such an FSM is formed to sweep only a frequency band corresponding to one of the frequency slots. Thereafter, the oscillator bank is appropriately switched sequentially to select the FSM and the oscillator set for each divided band so that the characteristic of the corresponding divided band is understood and thus, the frequency characteristic of the entire band of the MMF. At this time, a frequency is swept in a transmitter, the characteristic of the frequency is measured in a receiver, and the result is then returned to the transmitter. Here, a method of simply measuring the intensity of a signal may be used as a method of measuring the characteristic of a signal. After having scanned all the frequency regions, it is determined which IF frequency band each signal will be impressed onto in the transmitter.

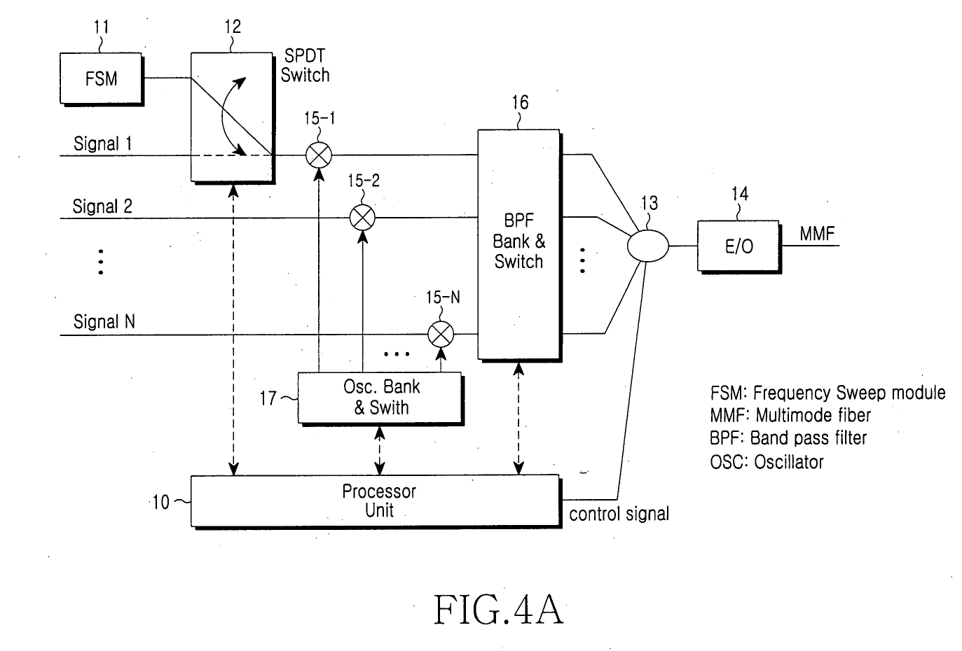

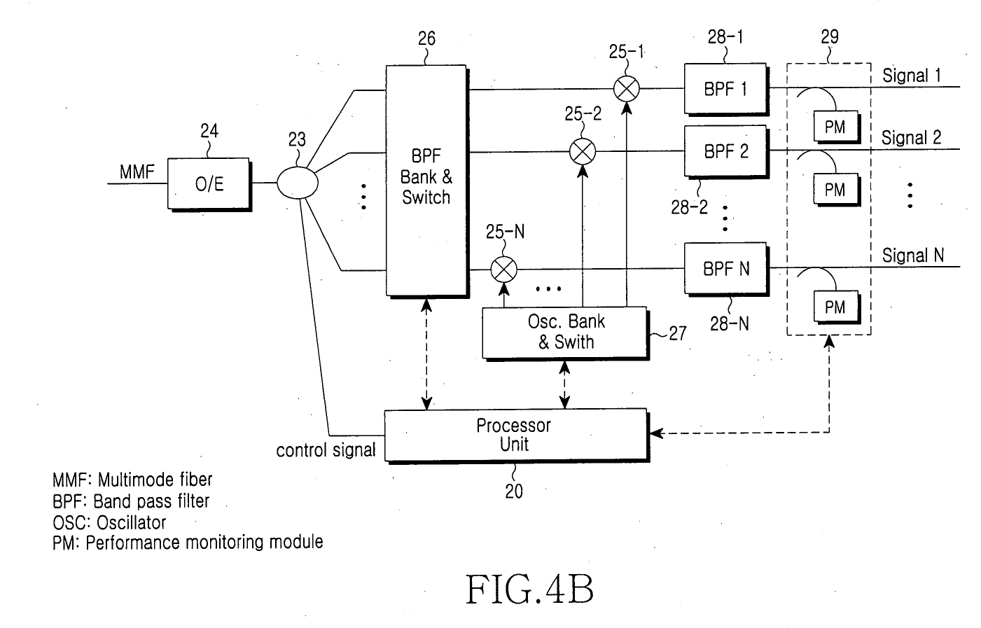

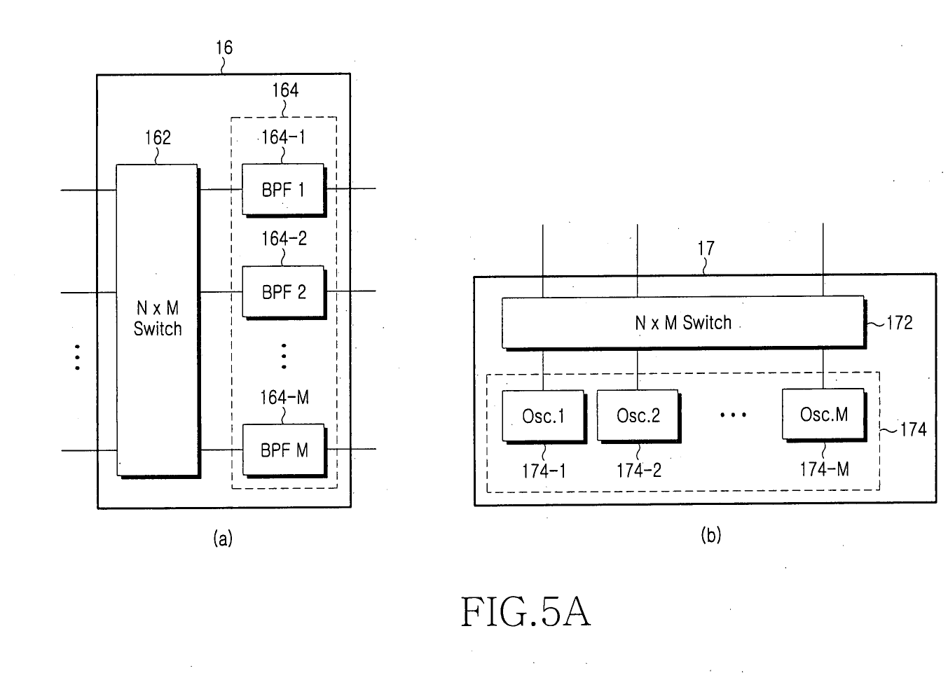

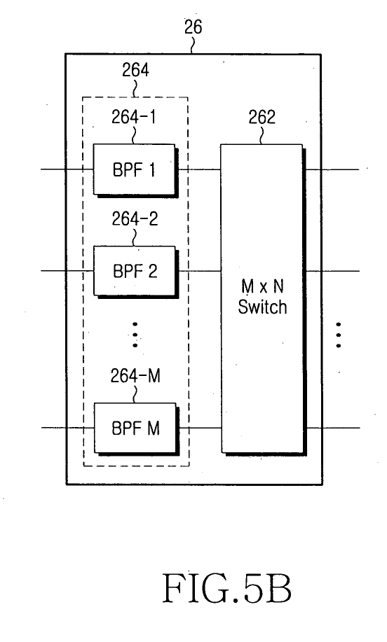

FIGS. 4A and 4B are block diagrams showing a configuration of an ROF link device using an MMF according to a first embodiment of the present invention. FIG. 4A illustrates a configuration of a transmitting device, and FIG. 4B illustrates a configuration of a receiving device. FIGS. 5A and 5B are detailed block diagrams showing configurations of a filter bank and switch 16 and an oscillator bank and switch 17 shown in FIG. 4A and a filter bank and switch 26 shown in FIG. 4B. Referring to FIG. 4A, the transmitting device includes a transmitting oscillator bank and switch 17 having a plurality of oscillators, each of which generates a reference frequency within a transmission band set for each frequency slot in a case where a preset band among the entire frequency band of the MMF is divided into a plurality of the frequency slots with the same bandwidth according to the features of the present invention, and for selecting one of the plurality of oscillators under the control of a transmitting side processor unit 10. A frequency sweep module 11 for outputting a variable frequency to sweep a frequency band corresponding to one of the frequency slots under the control of the transmitting side processor unit 10. A first mixer 15-1 for synthesizing outputs of the frequency sweep module 11 and the oscillator bank and switch 17. A transmitting side filter bank and switch 16 having a plurality of filters with filtering bands set for the plurality of frequency slots to select a signal output from the first mixer 15-1 to pass through the filter with the corresponding frequency band under the control of the transmitting side processor unit 10. The transmitting side processor unit 10 controls the frequency sweep module 11, oscillator bank and switch 17 and filter bank and switch 16 to transmit a corresponding optical signal to the receiving side device for each of the frequency slots, and receiving information on the quality of a corresponding transmitted signal transmitted from the receiving side device in order to identify frequency bands of the MMF possible for signal transmission (i.e., frequency slots possible for signal transmission) in a system initialization or system modification operation.

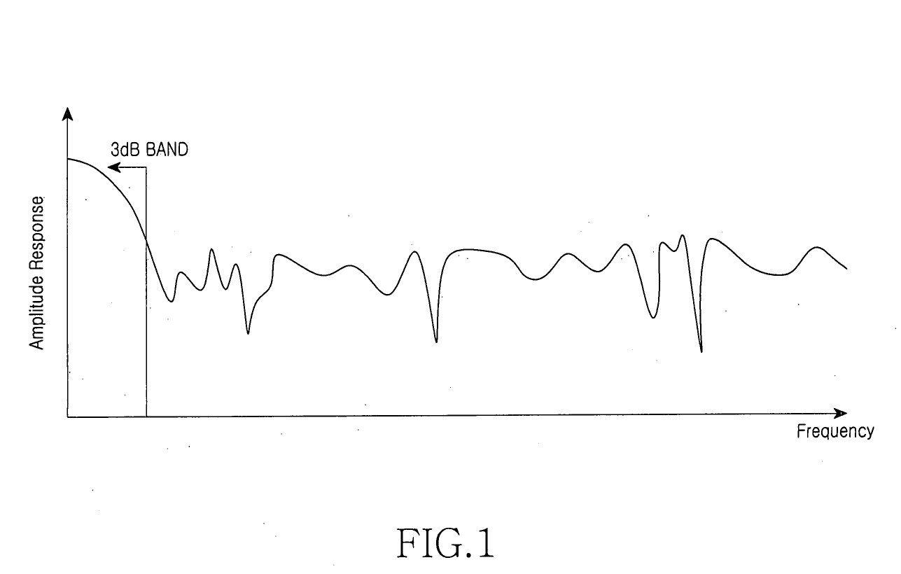

In order to perform an operation of identifying the frequency band(s) of the MMF possible for signal transmission in initial operation or at determined times (e.g., periodically), the transmitting side processor unit 10 controls the operation of a Single Pole Dual Through (SPDT) switch 12 such that the signal path with the mixer 15-1 of a specific signal (signal 1 in the example of FIG. 1) among signals to be transmitted is switched to the frequency sweep module 11 through the SPDT switch 12.

Further, the transmitting side device includes a plurality of mixers 15-1, 15-2, . . . 15-N for synthesizing various service signals (signal 1, 2, . . . N) with frequencies generated from the specific oscillators of the transmitting side oscillator bank and switch 17. The transmitting side processor unit 10 controls the switching operations of the transmitting side oscillator bank and switch 17 such that a signal to be transmitted can be synthesized with an appropriate frequency in accordance with the frequency slot possible for signal transmission as described above, and further controls the switching operations of the transmitting side filter bank and switch 16 such that an output of each of the mixers 15-1, 15-2, . . . 15-N can pass through a corresponding band pass filter. Further, the transmitting side processor unit 10 outputs proper control information to inform the receiving side device of the frequency slot to be currently identified, and such control information may be a switching control signal of the transmitting side oscillator bank and switch 17 or filter bank and switch 16. An additional control channel is provided to transmit information on the quality of a signal in the receiving side device as well as control information transmitted from the transmitting side processor unit 10 to the receiving side device in this manner.

The transmitting side device further includes a transmitting side combiner/divider 13 for combining control information output from the transmitting side processor unit 10 and each output of the filter bank and switch 16; and a transmitting side photoelectric converter 14 for converting a combined signal in the combiner/divider 13 into an optical signal to transmit it to the receiving side device through the MMF. The transmitting side photoelectric converter 14 converts an optical signal transmitted from the transmitting side device into an electric signal and outputs it to transmitting side combiner/separator 13, which divides such an electric signal output from the transmitting side photoelectric converter 14. Here, a control channel signal in the received signal separated the transmitting side combiner/divider 13 is provided to the transmitting side processor unit 10.

Referring to FIG. 4B, the receiving side device includes a receiving side photoelectric converter 24 for receiving an optical signal with a plurality of IF bands, which is transmitted from the transmitting side device through the MMF, and converts the received optical signal into an electric signal. A receiving side combiner/divider 23 for dividing a signal output from the receiving side photoelectric converter 24 depending on the number of the frequency slots, and dividing a control channel signal to output it. The receiving side combiner/divider 23 further outputs information regarding the quality of a signal output determined by a receiving side processor unit 20 to the receiving side photoelectric converter 24, and the receiving side photoelectric converter 24 converts it into an optical signal to transmit it to the transmitting side device.

The receiving side device further includes a receiving side filter bank and switch 25 having a plurality of filters, each of which receives a signal divided for each of the frequency slots through the receiving side combiner/divider 23 to filter the divided signal with each transmission band set for each of the frequency slots under the control of a receiving side processor unit 20, and for switching a path such that each of the signals filtered from the plurality of filters can be output to a preset output line in accordance with the signal band of an original signal. A receiving side oscillator bank and switch 27 having a plurality of oscillators, each of which generates a reference signal for modulating a frequency within each transmission band set for each of the frequency slots to the signal band of an original signal, and for selecting one of the plurality of oscillators under the control of the receiving side processor unit 20; a plurality of mixers 25-1, 25-2, . . . 25-N each of which is provided for each output line of the receiving side filter bank and switch 25, and synthesizes an output of the filter bank and switch 25 and an output of the receiving side oscillator bank and switch 27 to modulate it to the signal band of an original signal. A plurality of band pass filters 28-1, 28-2, . . . 28-N for respectively filtering output signals of the plurality of mixers 25-1, 25-2, . . . 25-N in corresponding frequency bands; and a Performance monitoring Module (PM) 29 for measuring the signal quality of output signals of the plurality of band pass filters 28-1, 28-2, . . . 28-N. The PM 29 may be configured as a plurality of intensity detectors for partially dividing each output of the plurality of band pass filters 28-1, 28-2, . . . 28-N to detect the intensity of a signal. Information on the quality of a signal detected from the PM 29 is provided to the receiving side processor unit 20, and the receiving side processor unit 20 transmits information on the quality of a signal for each of the corresponding frequency slots to the transmitting side device.

FIG. 5A(a) illustrates a detailed block diagram of the transmitting side filter bank and switch 16 in FIG. 4A, and FIG. 5A(b) illustrates a detailed block diagram of the transmitting side oscillator bank and switch 17 in FIG. 4A. As shown in FIG. 5A(a), the transmitting side filter bank and switch 16 is provided with a filter bank 164 having a plurality of band pass filters 164-1, 164-2, . . . 164-M with filtering bands respectively set for the plurality of frequency slots, and an N×M switch 162 for switching the input paths of the plurality of band pass filters 164-1, 164-2, . . . 164-M. Further, the transmitting side oscillator bank and switch 17 (FIG. 5A(b) is provided with an oscillator bank 174 having a plurality of oscillators 174-1, 174-2, . . . 174-M for generating reference frequencies of transmission bands set for the plurality of frequency slots, respectively, and an N×M switch 172 for switching the output paths of the plurality of oscillators 174-1, 174-2, . . . 174-M. N in each of the N×M switches 162 and 172 is the number of input signals, and M is the number of output signals, i.e., the number of oscillators or band pass filters in the bank. M is generally larger than N in the aforementioned configuration. Referring to FIG. 5B, the receiving side filter bank and switch 26 is provided with a filter bank 264 having a plurality of band pass filters 264-1, 264-2, . . . 264-M with filtering bands set for the plurality of frequency slots, respectively, and an N×M switch 262 for switching the output paths of the plurality of band pass filters 264-1, 264-2, . . . 264-M. A detailed hardware configuration of the receiving side oscillator bank and switch 27 may be identical with the configuration of the transmitting side oscillator bank and switch 17 shown in FIG. 5A(b).

An operation of the ROF link device using an MMF, which has the configuration described above according to the first embodiment of the present invention, is next described. First, if a system is initially operated, the frequency characteristics of the MMF are understood or determined. The transmitting side processor unit 10 switches the SPDT switch 12 to the frequency sweep module 11, which sweeps a frequency range. The proper oscillator and band pass filter are sequentially selected in the transmitting side oscillator bank and switch 17 and filter bank and switch 16 so that the frequencies for all the scanning regions are swept. A corresponding band pass filter identical with that of the transmitting side device is also selected in the receiving side device. A transmission characteristic (e.g., the intensity of a signal) is measured through the PM 29 and the result and measured transmission characteristic is transmitted to the transmitting side device through a control channel. In the transmitting side device, the frequency sweep and the frequency characteristic thereof for the entire MMF frequency range is obtained, and it is determined at which IF frequency a signal will be impressed onto. Control information on the determined IF frequency(ies) is then transmitted to the receiving side device such that the receiving side can appropriately perform switching. Thereafter, each input signal is modulated using a proper IF determined after the switch is appropriately adjusted in the transmitting side device. The signals modulated in this manner are combined together (device 13), converted into an optical signal (device 14), and then transmitted to the receiving side device through the MMF.

In the receiving side device, a control signal transmitted from the transmitting side device is first received to select proper oscillator and band pass filter, and an appropriate switching operation is performed. After the optical signal input to the receiving side device has been divided into various signals by the receiving side combiner/divider 23, the various signals pass through the filter bank and switch 26. In a preferred aspect, a switch structure is used in the filter bank & switch 26 and the oscillator bank & switch 27 of the receiving side device is used for the purpose of outputting the signals in the order of original signals. That is, since each of the band pass filters 28-1, 28-2, . . . 28-N is a band pass filter designed to be suitable for each of the original signals, the switch structure is required to output each of the original signals to a proper position (output line). The signals having passed through the receiving side filter bank & switch 26 are re-modulated as original frequency bands through combinations with the proper oscillators by the oscillator bank & switch 27 and the plurality of mixers 25-1, 25-2, . . . 25-N, respectively. Thereafter, the quality of the signals having passed through the band pass filters 28-1, 28-2, . . . 28-N is measured.

An operation for such signal quality may be repeatedly performed in an initial operation of the system or at appropriate period(s). The re-arrangement of the IF signal bands may be executed in accordance with the quality measurement result. In this case, the IF signal band of a specific frequency slot with bad signal quality may be modified, and the IF signal band of the entire signal band may be re-arranged.

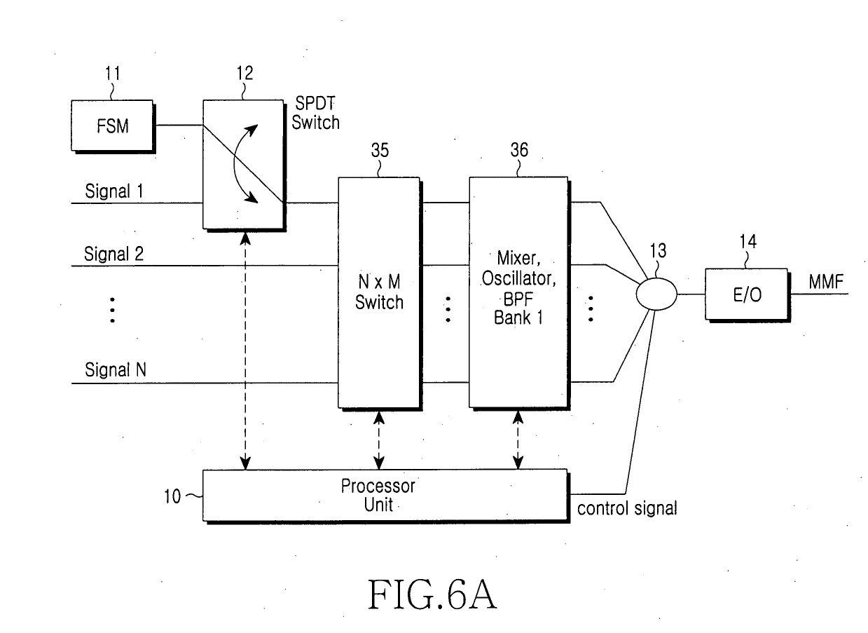

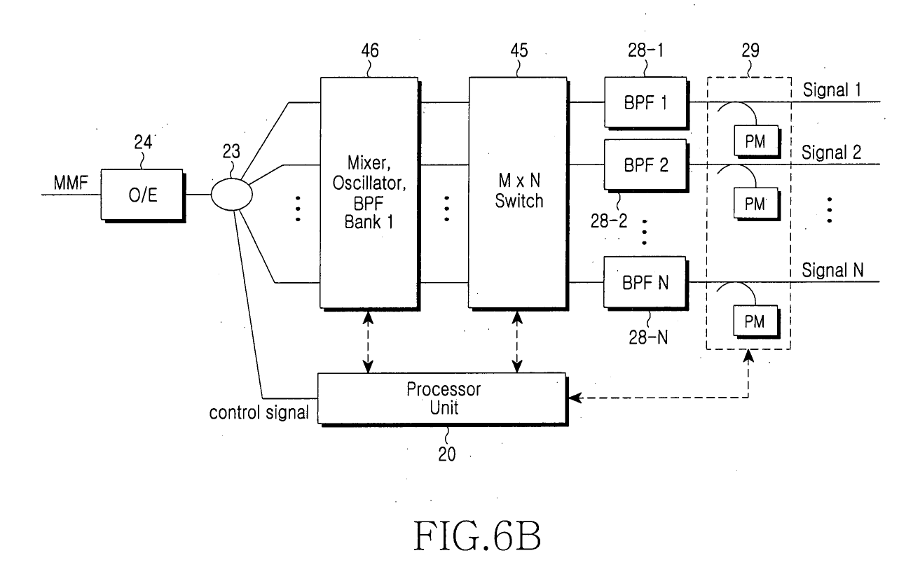

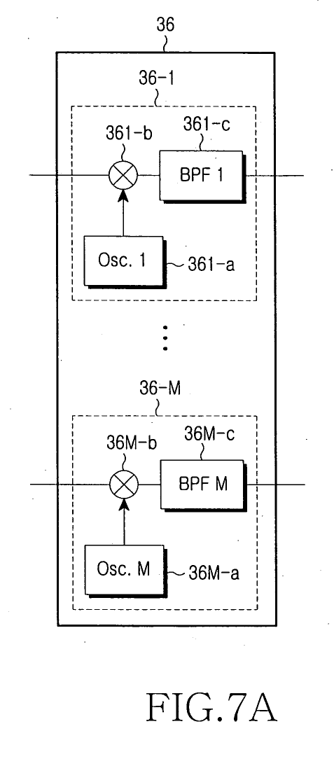

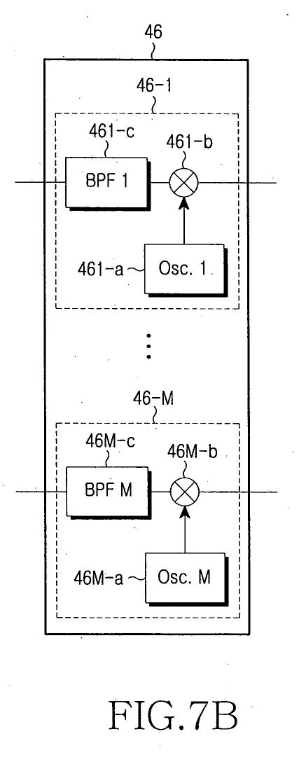

FIGS. 6A and 6B represent block diagrams showing a configuration of an ROF link device using an MMF according to a second embodiment of the present invention. FIG. 6A illustrates a configuration of a transmitting side device, and FIG. 6B illustrates a configuration of a receiving side device. FIGS. 7A and 7B represent detailed block diagrams showing configurations of mixer/oscillator/filter banks in FIGS. 6A and 6B, respectively. Referring to FIGS. 6A and 7B, the configuration of the transmitting side device, according to the second embodiment of the present invention, includes a frequency sweep module 11, an SPDT switch 12, which are identical with the configuration shown in FIG. 4A according to the first embodiment of the present invention, and performs operations similar thereto. However, the configuration of the transmitting side device, according to the second embodiment of the present invention, is different from that according to the first embodiment of the present invention in that the configuration includes a transmitting side mixer/oscillator/bank 36 having a plurality of cells 36-1, . . . 36-M (and shown in greater detail in FIG. 7A), each of which modulates a signal input by appropriately configuring each mixer 361-b, . . . 36M-b, oscillator 361-a, . . . 36M-a and band pass filter 361-c, . . . 36M-c as one cell for each frequency slot to a signal of the corresponding frequency slot and a transmitting side switch 35 (N×M switch) for appropriately switching an input terminal of the transmitting side mixer/oscillator/bank 36 and the signal path of a signal to be transmitted under the control of a processor unit 10.

FIGS. 6B and 7B, represent the configuration of the receiving side device, according to the second embodiment of the present invention, is similar to that shown in FIGS. 4A. However, the configuration of the receiving side device, according to the second embodiment of the present invention, is different from that according to the first embodiment of the present invention in that the configuration includes: a receiving side mixer/oscillator/bank 46 having a plurality of cells 46-1, . . . 46-M (FIG. 7B), each of which modulates a signal input by appropriately configuring each mixer 461-b, . . . 46M-b, oscillator 461-a, . . . 46M-a and band pass filter 461-c, . . . 46M-c as one cell for each frequency slot to a signal of the corresponding frequency slot and a transmitting side switch 45 (N×M switch) for appropriately switching an output terminal of the transmitting side mixer/oscillator/bank 36 and a signal path between output lines of an original signal band under the control of a processor unit 20.

The transmitting and receiving side devices provided with the aforementioned configurations, according to the second embodiment of the present invention, represent a simplified switch structure as compared with the configuration shown in FIGS. 4A, 4B according to the first embodiment of the present invention. That is, in a case of FIGS. 4A and 4B, two switch blocks are required in the respective transmitting and receiving side devices. One is for the purpose of selecting an oscillator, and the other is for the purpose of selecting a band pass filter. On the other hand, in a case of the second embodiment of the present invention shown in FIGS. 6A, 6B, only one switch block is required in the respective transmitting and receiving side devices.

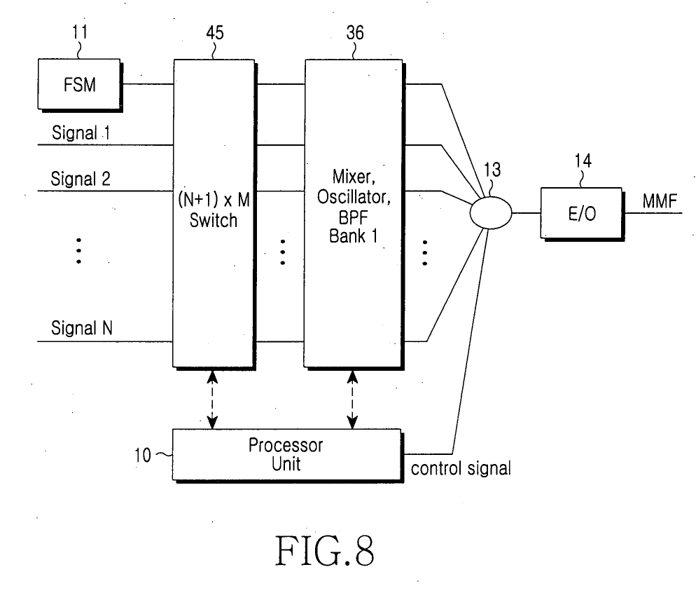

FIG. 8 represents a block diagram showing a configuration of a transmitting side device in an ROF link device using an MMF according to a third embodiment of the present invention. A configuration of a receiving side device may be identical with that of the second embodiment of the present invention show in FIGS. 6B and need not be discussed in further detail. Referring to FIG. 8, the transmitting side device, according to the third embodiment of the present invention, is almost identical with the configuration of the second embodiment of the present invention shown in FIG. 6A. However, the transmitting side device, according to this third embodiment of the present invention, is different from the configuration of the second embodiment of the present invention in that the transmitting side device does not include an additional SPDT switch 12 for setting the path of a frequency sweep module 11 as shown in FIG. 6A. In this case, a path of the frequency sweep module 11 is set under the control of a transmitting side processor unit 10 using an (N+1)×M switch in which an input terminal is added to the configuration of the input terminals of the transmitting side mixer/oscillator/bank 36 shown in FIG. 6A and the transmitting side switch 35 for appropriately switching the signal path of a signal to be transmitted.

As described above, an ROF link method using the MMF, according to the present invention, can simultaneously receive different services using different transmission regions within the MMF. A proper IF band is searched for in an bandwidth to receive different services so that substantially uniform performance can be obtained regardless of the kind, length and connection state of the MMF. Further, since IF bands are automatically selected when a link is first installed, there is no need to individually tune the IF bands. Accordingly, installation costs can be reduced, and real performance monitoring is possible for each service. As the frequency characteristics of the MMF is previously understood to re-arrange input signals, transmission bands can be more effectively selected in the various signals. Besides, the ROF link method is configured without using a variable frequency oscillators and variable frequency band pass filters so that it is effective in terms of performance and cost, and there is not additionally required a control function for stability in use during a long period of time.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A Radio-Over-Fiber (ROF) link system using a Multi-Mode Fiber (MMF), comprising:
a transmitting side device transmitting at least one optical signal via the Multi-Mode Fiber to a receiving side device;
the transmitting device comprising:
a transmitting side processor unit;
a transmitting side oscillator bank & switch having a plurality of oscillators, each of which generates a reference frequency with a transmission band set for each frequency slot wherein a preset band within the entire frequency band of the MMF is divided into a plurality of the frequency slots with substantially a same bandwidth, and for selecting one of the plurality of oscillators under the control of the transmitting side processor unit;
a frequency sweep module for outputting a variable frequency to sweep a selected frequency band corresponding to one of the frequency slots under the control of the transmitting side processor unit;
a first mixer for synthesizing outputs of the frequency sweep module and the oscillator bank & switch; and
a transmitting side filter bank & switch comprising a plurality of filters with filtering bands corresponding to the plurality of frequency slots operable to select a signal output from the first mixer to pass through the filter with the corresponding frequency band under the control of the transmitting side processor unit,
wherein the transmitting side processor unit further receiving information on the quality of a corresponding transmitted signal transmitted from a receiving side device in order to identify frequency bands of the MMF possible for signal transmission.

2. The ROF link system as claimed in claim 1, wherein the transmitting side device comprises:
a plurality of mixers for synthesizing various service signals with a frequency generated from one oscillator in the transmitting side oscillator bank & switch; and
a switch for switching a signal path of one in the plurality of service signals and mixers with a signal path of the frequency sweep module under the control of the transmitting side processor unit.

3. The ROF link system as claimed in claim 1, wherein the receiving side device comprises:
a receiving side processing unit;
a receiving side filter bank & switch having a plurality of filters, each of which receives a signal divided for each number of frequency slots through the receiving side device to filter the divided signal with each transmission band set for each of the frequency slots under the control of the receiving side processor unit, and for switching a path such that each of the signals filtered from the plurality of filters can be output to a preset output line in accordance with the signal band of an original signal;
a receiving side oscillator bank & switch having a plurality of oscillators, each of which generates a reference signal for modulating a frequency with each transmission band set for each of the frequency slots to the signal band of an original signal, and for selecting one of the plurality of oscillators under the control of the receiving side processor unit;
a plurality of mixers each of which is provided for each output line of the receiving side filter bank & switch, and synthesizes an output of the filter bank & switch and an output of the receiving side oscillator bank & switch to modulate it to the signal band of an original signal;
a plurality of band pass filters for respectively filtering output signals of the plurality of mixers in corresponding frequency bands; and
a performance monitoring Module (PM) for measuring the signal quality of output signals of the plurality of band pass filters,
wherein the receiving side processor unit receiving a control signal transmitted from the transmitting side device to measure signal quality for each of the frequency slots through the PM, and to transmit information regarding the signal quality detected from the PM to the transmitting side device.

4. The ROF link system as claimed in claim 1, wherein the receiving side device comprising:
a receiving side processor unit;
a receiving side mixer/oscillator/bank having a plurality of cells each of which receives a signal divided for each number of frequency slots through the receiving side device to filter the divided signal with each transmission band set for each of the frequency slots so as to modulate a signal input by configuring each band pass filter, mixer and oscillator as one cell for each of the frequency slots to the frequency band of an original signal;
a receiving side switch for switching a signal path between an output terminal of the receiving side mixer/oscillator/bank and the output line of an original signal band under the control of a receiving processor unit;
a plurality of band pass filters for filtering the output signal of the receiving side switch for each frequency band of the corresponding original signal; and
a PM for measuring the signal quality of output signals of the plurality of band pass filters; wherein having the receiving side processor unit controls the receiving side filter bank & switch and oscillator bank & switch in accordance with a control signal transmitted from the transmitting side device to measure signal quality for each of the frequency slots through the PM, and to transmit information on the signal quality detected from the PM to the transmitting side device.

5. The ROF link system as claimed in claim 3, wherein the PM is configured as a plurality of intensity detectors for partially dividing each output of the plurality of band pass filters to detect the intensity of a signal.

6. An ROF link transmitting device for transmitting at least one signal over an optical network using an MMF, comprising:
a transmitting side mixer/oscillator/bank having a plurality of cells each of which modulates a signal input by configuring each band pass filter, mixer and oscillator as one cell for each of the frequency slots to a signal of the corresponding frequency slot in a case where a preset band among the entire frequency band of the MMF is divided into the plurality of the frequency slots with the same bandwidth;
a frequency sweep module for outputting a variable frequency to sweep a frequency band corresponding to one of the frequency slots under the control of a transmitting side processor unit; and
a transmitting side switch for switching an input terminal of the transmitting side mixer/oscillator/bank, a signal path of a signal to be transmitted and an output path of the frequency sweep module under the control of the transmitting side processor unit,
wherein the transmitting side processor unit controls the frequency sweep module and the transmitting side switch to transmit a corresponding optical signal to the receiving side device for each of the frequency slots, and receiving information on the quality of a corresponding transmitted signal in order to identify frequency bands of the MMF possible for signal transmission.

7. A ROF link receiving device, comprising:
a receiving side filter bank & switch having a plurality of filters, each of which receives a signal divided for each number of frequency slots through the receiving side device to filter the divided signal with each transmission band set for each of the frequency slots under the control of a receiving side processor unit, and for switching a path such that each of the signals filtered from the plurality of filters can be output to a preset output line in accordance with the signal band of an original signal;
a receiving side oscillator bank & switch having a plurality of oscillators, each of which generates a reference signal for modulating a frequency with each transmission band set for each of the frequency slots to the signal band of an original signal, and for selecting one of the plurality of oscillators under the control of the receiving side processor unit;
a plurality of mixers each of which is provided for each output line of the receiving side filter bank & switch, and synthesizes an output of the filter bank & switch and an output of the receiving side oscillator bank & switch to modulate it to the signal band of an original signal;
a plurality of ban pass filters for respectively filtering output signals of the plurality of mixers in corresponding frequency bands;
a PM for measuring the signal quality of output signals of the plurality of band pass filters; and
a receiving side processor unit for controlling the receiving side filter bank & switch and oscillator bank & switch in accordance with a control signal to measure signal quality for each of the frequency slots through the PM, and to transmit information on the signal quality detected from the PM.

8. A ROF link receiving device, comprising:
a receiving side mixer/oscillator/bank having a plurality of cells each of which receives a signal divided for each number of frequency slots through the receiving side device to filter the divided signal with each transmission band set for each of the frequency slots so as to modulate a signal input by configuring each band pass filter, mixer and oscillator as one cell for each of the frequency slots to the frequency band of an original signal;
a receiving side switch for switching a signal path between an output terminal of the receiving side mixer/oscillator/bank and the output line of an original signal band under the control of a receiving processor unit;
a plurality of band pass filters for filtering the output signal of the receiving side switch for each frequency band of the corresponding original signal; and
a PM for measuring the signal quality of output signals of the plurality of band pass filters,
wherein the receiving side processor unit controls the receiving side filter bank & switch and oscillator bank & switch in accordance with a control signal to measure signal quality for each of the frequency slots through the PM, and to transmit information on the signal quality detected from the PM.

9. The ROF receiving link device as claimed in claim 7, wherein the PM is configured as a plurality of intensity detectors for partially dividing each output of the plurality of band pass filters to detect the intensity of a signal.

10. A method of setting a signal band of a hybrid ROF/optical system using an MMF, comprising the steps of:
dividing a preset band of the entire frequency band of the MMF as a plurality of frequency slots to preset a transmission band in a transmitting side device;
sequentially sweeping a plurality of reference frequencies predetermined for each transmission band of the plurality of the frequency slots to only the bands of the corresponding frequency slots;
identifying the possibility of signal transmission for each of the plurality of frequency slots in accordance with transmission quality information transmitted from a receiving side to set a transmission signal band;
detecting the quality of a signal received for the corresponding frequency slot when sweeping a frequency for each of the plurality of frequency slots in the receiving side device; and
transmitting the transmission quality information to the transmitting side device in accordance with the detected signal quality.

11. The method as claimed in claim 10, wherein the detection of the signal quality is the detection of the intensity of a received signal.

12. The ROF link system as claimed in claim 4, wherein the PM is configured as a plurality of intensity detectors for partially dividing each output of the plurality of band pass filters to detect the intensity of a signal.

13. The ROF receiving link device as claimed in claim 8, wherein the PM is configured as a plurality of intensity detectors for partially dividing each output of the plurality of band pass filters to detect the intensity of a signal.
